(19) United States
(12) Patent Application Publication
(10) Pub. No.: US 2020/0059750 A1
(43) Pub. Date: Feb. 20, 2020

(54) SOUND SPATIALIZATION METHOD

(71) Applicant: AXD Technologies, LLC, Los Angeles, CA (US)

(72) Inventors: Jean-Luc Haurais, Paris (FR); Franck Rosset, Bruxelles (BE)

(21) Appl. No.: 16/603,536

(22) PCT Filed: Apr. 7, 2018
(86) PCT No.: PCT/IB2018/052427

§ 371 Date: Oct. 7, 2019

(30) Foreign Application Priority Data
Apr. 7, 2017 (FR) 17/53023

(51) Int. Cl. H04S 7/00; H04R 5/04; H04R 3/04; H04R 3/00

(52) U.S. Cl. CPC H04S 7/303; H04S 7/307; H04R 5/04; H04S 2400/13; H04R 3/005; H04S 2420/01; H04R 3/04

(57) ABSTRACT

The present disclosure relates to a method and equipment for sound spatialization comprising applying the filtering of a sound signal with a transfer function which takes into account a determined profile through the acquisition of an impulse response of a reference room, characterized in that it includes a step of modifying said transfer function according to a signal representative of the amplification amount.

### RELATED APPLICATIONS

This application is the U.S. National Stage application under 35 U.S.C. § 371 of International Application No. PCT/IB2018/052427, filed on Apr. 7, 2018, which claims the benefit of priority to French Application No. 17/53023, filed Apr. 7, 2017, the disclosures of which are hereby incorporated by reference in their entireties. Any and all applications for which a foreign or domestic priority claim is identified in the Application Data Sheet of the present application are hereby incorporated by reference under 37 CFR 1.57.

### TECHNICAL FIELD

The present disclosure relates to the field of sound spatialization making it possible to create the illusion of sound localization specifically when listening with headphones, and an immersive sensation.

### BACKGROUND

Human hearing is able to determine the position of sound sources in space, mainly on the basis of the comparison between the sound signals received by both ears, and by comparing direct sound/reverberation, or by means of a spectral processing.

Techniques largely depend on the listening system (stereophony, multichannel, etc.). Headphone listening makes it possible to precisely select what the ears will perceive: irrespective of the channel dedicated to the other ear, and with no HRTF filtering performed by the head.

Spatialization makes it possible to enhance the perception of the sound space consistency and the intelligibility thereof depends thereon. The listener can localize sound sources using his/her hearing system only and for instance perceive that a car is driving straight at him/her, or if it drives at a 100 m distance, or if a dog is barking at the neighbor's or if it is right in front of him/her, and thus ensure consistency between video and the soundscape associated therewith.

The two ears perceive sounds having different gain, phase and reflection and brain makes a detailed analysis thereof to compute the results and localize the perceived sound with more or less accuracy.

The first difference in perception of the two ears is the difference in gain: one sound is located on the right and the right ear hears such sound much louder than the left ear. The closer to the ear the sound is, the greater the difference in gain. The reason therefore is quite simple: the distance between the two ears is about 20 cm and such distance is added to the one covered by the sound. A sound located 20 cm away from one ear doubles the distance to the other ear (=minus 6 dB).

The second difference perceived is the difference in phase: when covering the distance from one ear to the other, sound reaches each ear with a different phase, except in the very particular and theoretical case of a sine wave which would exactly correspond to the distance between the two ears. Brain is capable of analyzing differences in phase without any problem and of drawing conclusions as regards the location of the sound source.

The third difference is based on the specificity of the ear, the shape thereof and the specific construction of our auditory system. Of course, the specific shape of our ears is such that sounds produced ahead of us will be amplified and the other sounds produced on the sides or behind us will be more or less attenuated.

Our brain thus uses such three differences in perception to analyze data and to compute and build a sound space.

The methods and devices relating to sound spatialization may involve giving an accurate spatial restitution of sounds in user's audio headphones. An audio headphone with no specific processing gives a degraded rendering of a multichannel mixing only, of a lower quality than that of a speaker diffusion. The aim of the spatialized audio restitution devices is simulating the origin of the sounds from several sources distributed in space. To deliver such spatialized rendering with a sufficient fidelity, the path differences between a sound source and each one of the user's ears and the interferences between the acoustic waves and the user's body should be taken into account. Such elements are traditionally measured so as to be included in a digital signal processing sequence intended to reproduce, for the user wearing headphones, the elements which will enable same to reconstitute the location of the sound sources, using Head Related Transfer Functions or HRTF.

### BRIEF DESCRIPTION OF THE DRAWINGS

The various embodiments of the present disclosure will be better understood with references to the following drawings, which disclose non-limiting exemplary embodiments, in which:

FIGS. 1 and 2 schematically show the positions of the virtual loudspeakers and the room effect to record a series of transfer functions,

FIG. 3 shows the impulse response of a signal of the «sweep» type,

FIG. 4 shows the time-frequency spectrum of an exemplary transfer function,

FIG. 5 shows the block diagram of a sound reproduction system.

### DETAILED DESCRIPTION

Solutions relating to spatialization may include, for instance, those disclosed in the European patent: Transaural synthesis method for sound spatialization EP2815589 which discloses a method for producing a digital spatialized stereo audio file from an original multichannel audio file, characterized in that it comprises:
a step of performing a processing on each of the channels for cross-talk cancellation;
a step of merging the channels in order to produce a stereo signal;
a dynamic filtering and specific equalization step for increasing the sound dynamics.

The French patent FR2851879 is also known, which discloses the processing of sound data, for a spatialized restitution of acoustic signals. At least a first set and a second set of weighting terms, representative of a direction of perception of said acoustic signal by a listener are obtained for each acoustic signal. Said acoustic signals are then applied to at least two sets of filtering units, disposed in parallel, for providing at least a first and a second output signal (L, R) corresponding to a linear combination of the signals delivered by these filtering units respectively weighted by the set of weighting terms of the first set and the second set. Each acoustic signal to be processed is at least partially encoded in compression and is expressed as a vector of sub-signals associated with respective frequency sub-bands. Each filtering unit performs a matrix filtering applied to each vector, in the space of frequency sub-bands.

The international patent application WO 2010061076 discloses another exemplary method for processing a signal, in particular a digital audio signal, suitable for being implemented by a digital signal processor (DSP) having libraries for calculating Fourier transforms from the complex number space to the complex number space, for digitally processing P input signals, P being an integer at least equal to 2, more particularly for filtering said P input signals by the convolution of sampled fast Fourier transforms (FFT), thus obtaining Q output signals, Q being an integer at least equal to 2. The method comprises at least the following steps:
grouping said P input signals by twos, with one representing the real portion, and the other one representing the imaginary portion of a complex number, thus defining one or more input vector(s),
filtering the input vector(s) passing through the Fourier space, thus generating one or more complex output vector(s), with the real portion and the imaginary portion of said or each of said output vector(s) respectively representing one of said Q output signals.

These solutions may make it possible to enhance sound spatialization when using listening headphones with a given listening level. Spatialization however depends on the audio level. If the sound level is too high, spatialization perception is lost. On the contrary, if the sound level is low, the spatialization effect is distorted and exaggerated and upsets the listener.

As a distant sound is less powerful, the sound level is the most evident adjustment to disclose remoteness.

Besides, the relative level of a sharp sound as compared to the reverberation thereof differs according to the listening level.

Eventually, as distance filters some frequencies, equalizing turning off the low (under 200 Hz) and high frequencies participates in the false impression of distance.

Embodiments of the present disclosure relate to a sound spatialization method comprising applying the filtering of a sound signal with a transfer function which takes into account a determined profile through the acquisition of an impulse response of a reference room, characterized in that it includes a step of modifying said transfer function according to a signal representative of the amplification amount.

Said modification of the transfer function advantageously comprising selecting a profile among a plurality of profiles, each corresponding to one acquisition of an impulse response of said reference room with a different distance.

According to a special alternative embodiment, the sound spatialization method is characterized in that it further comprises steps of calculating, in real time, synectic profiles by combining at least two previously saved profiles.

According to another alternative embodiment, said modification of the transfer function comprising selecting a variable length sequence of said profile, with the size of said sequence depending on the amplification amount.

Embodiments of the present disclosure also relate to sound spatialization equipment for implementing the method comprising a computer for executing a process comprising applying the filtering of a sound signal with a transfer function which takes into account a determined profile through the acquisition of an impulse response of a reference room, characterized in that said computer includes means for selecting a series of transfer functions according to a signal representative of the amplification amount.

### Transfer Function Encoding

Binaural technologies can be broken down into two categories:
natural encoding: Binaural signals are acquired using a recording by positioning a pair of microphones at an individual's or a dummy's (artificial head) auditory meatus. Such variation is applied for recording sound scenes for sharing a sound environment or for the sonic postcard concept.
artificial encoding: Binaural sounds are obtained by means of a binaural synthesis by convolving a monaural signal representing the signal emitted by the sound source by a pair of filters modelling the transfer functions associated with the left and right ears relative to a given source position. Potentially, the transfer functions can take into account the room effect associated with the acoustic environment of the sound sources. Unlike recording, binaural syntheses give complete freedom for positioning and controlling sound sources.

### Physical Acquisition of the Transfer Functions

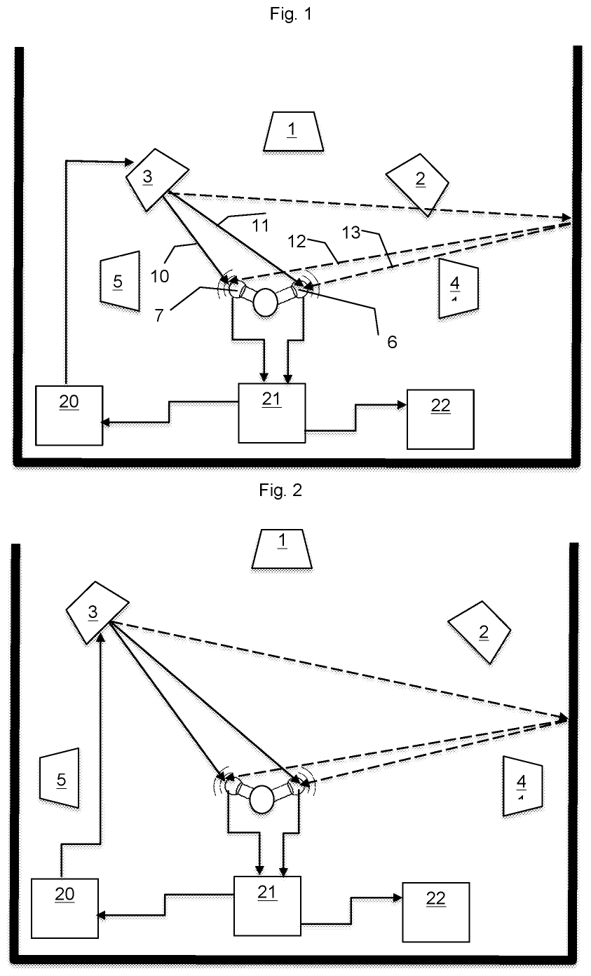

FIGS. 1 and 2 schematically show the positions of the loudspeakers and the room effect to record a series of transfer functions.

In the example shown, a plurality of loudspeakers 1 to 5 surround a couple of microphones 6, 7, for instance as an artificial head.

The loudspeakers 1 to 5 are placed in a first position, at an intermediate distance relative to the microphones 6, 7. They are both supplied with a reference signal, for instance a short white noise, for instance a «clap ». Each microphone receives a direct sound wave and a sound wave reverberated by the walls of the sound room.

For each loudspeaker 1 to 5, the (ipsilateral 10 in the example shown) acoustic path from the loudspeaker 3 to the left microphone 7, as well as the (contralateral 11 in the example shown) acoustic path from the loudspeaker 3 to the right microphone 6, as well as reflections on the walls (path 12, 13)), and eventually a diffuse field after several reflections. Upon each reflection, the sound wave is attenuated in the highest frequencies.

The loudspeakers 1 to 5 are then moved as shown in FIG. 2, to a distance different from the previous one, and the process of microphones 6, 7 acquiring sound recordings is repeated.

A series of sound acquisitions corresponding to various orientations is then recorded, as grouped according to the loudspeakers positioning distances, which thus makes it possible to compute transfer functions as impulse responses, using known processes.

A generator 21 producing a reference signal amplified by an amplifier 20 is used to compute the transfer functions. Such signal is also transmitted to a computer 22 which receives the signals from the two microphones 6, 7 to execute the computing of a binaural filter.

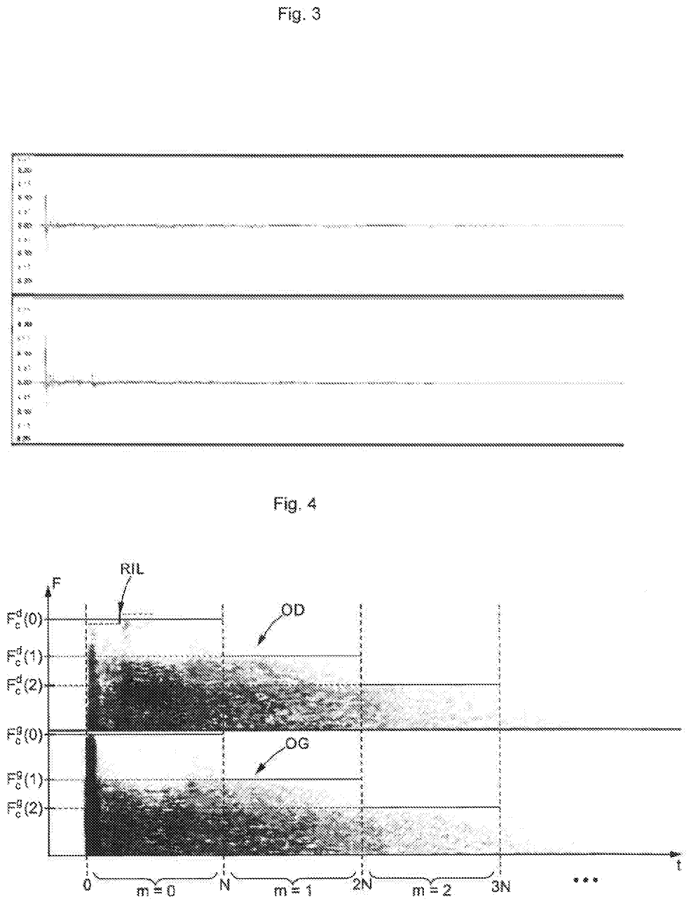

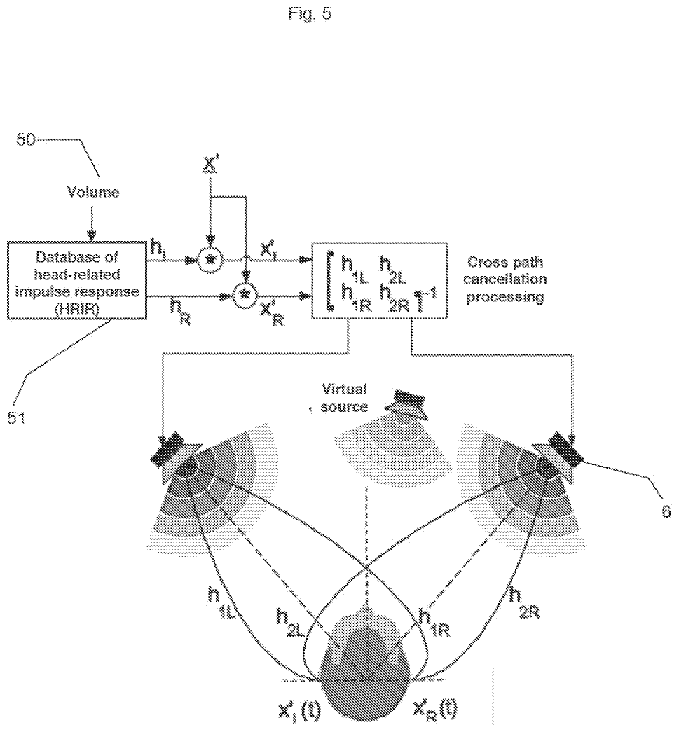

FIG. 3 shows the impulse response of a «sweep» type signal and FIG. 4 illustrates a time-frequency diagram of a transfer function corresponding to the acquisition by a loudspeaker 3 at a given distance. Considering a first time frame from 0 to N-1, and noted m=0, the maximum frequency Fcd(0) of a filter representing the transfer function specific to the right ear may be lower than the maximum frequency Fcg(0) of a filter representing the transfer function specific to the left ear. The components of the filter thereof for the right ear can thus be limited to the cut-off frequency Fcd(0) even though the signal to be processed can have higher spectral components, up to the frequency Fcg(0) at least. Then, after reflections, the acoustic wave tends to attenuate in the high frequencies, which is correctly complied with by the time-frequency diagram of the transfer function for the left ear, as for the right ear, for the N to 2N-1 instants, corresponding to the following frame noted m=1. It can thus be provided to limit the filter components for the right ear to the cut-off frequency Fcd(1) and for the left ear to the cut- off frequency Fcg(1).

The shorter frames make it possible to obtain a finer variation in the highest frequency to be considered, for instance to take into account a first reflection for which the highest frequency increases for the right ear (dotted lines around Fcd(0) in FIG. 4) during the first instants in the frame m=0. All the spectral components of one filter representing a transfer function, specifically beyond a cut-off frequency Fc may not be taken into account. As a matter of fact, the convolution of a signal by a transfer function becomes, in the spectral range, a multiplication of the spectral components of the signal by the spectral components of the filter representing the transfer function in the spectral range, and, more particularly, such multiplication can be executed up to a cut-off frequency only, which depends on a given frame, for instance, and on the signal to be processed.

### Reproduction through Headphones or a Pair of Loudspeakers

An alternative to the headphone solution is listening with a two-loudspeaker system, for instance the loudspeakers on the front of a lap-top. If such loudspeakers are supplied with the binaural signals, and not earphones of a headphone, crosstalk shall have to be processed: the left (respectively right) binaural signal which is intended to the left (respectively right) ear only is perceived not only by the left (respectively right) ear, but also by the right (respectively left) ear modulo the circumventing of the head. Such crosstalk between the two ears destroys the illusion of the virtual sound scene. The general solution is based on a pre-processing of the binaural signals upstream of the diffusion by the loudspeakers: the spurious signal resulting from the crosstalk is injected in phase opposition into the original binaural signal, so as to cancel the circumventing wave upon diffusion. This is the crosstalk canceller process.

The series of transfer functions are recorded in a data base 51, with an indicator corresponding to the rank of the acquisition distance during the acquisition phase.

The selection of the series is controlled by a signal 50 corresponding to the listening level for instance from the man-machine interface controlling a digital amplifier.

The computer determines the appropriate rank according to the level selected on the amplifier:
for a high level, the rank corresponding to the series of transfer functions acquired with the loudspeakers 1 to 5 positioned far away, which corresponds to a long impulse response IR, of the order of 400 ms to 2 s, acquired with loudspeakers 1 to 5 positioned at a distance from 3 to 5 meters from the microphones 6, 7.
for a low level, the rank corresponding to the series of transfer functions acquired with the loudspeakers 1 to 5 positioned at a short distance, which corresponds to a short impulse response IR, of the order of 50 ms to 1 s, acquired with loudspeakers 1 to 5 positioned at a distance from 1 to 2 meters from the microphones 6, 7.

1. (canceled)

2. (canceled)

3. (canceled)

4. (canceled)

5. (canceled)

6. A sound spatialization method, comprising:
filtering a sound signal with a transfer function, wherein the transfer function is based on an impulse response associated with a sound acquisition environment; and
providing, via a pair of headphones or loudspeakers, a spatial restitution of sounds based on the filtered sound signal at a listening level associated with a digital amplifier,
wherein the transfer function is determined according to a signal representative of the listening level associated with the digital amplifier.

7. The sound spatialization method of claim 6, wherein the transfer function is recorded in a database along with an indicator corresponding to a rank of a sound acquisition distance associated with the transfer function.

8. The sound spatialization method of claim 6, wherein the determination of the transfer function comprises selecting the transfer function based on a signal from a man machine interface controlling the digital amplifier.

9. The sound spatialization method of claim 6, further comprising determining a rank according to the listening level selected on the digital amplifier, and selecting the transfer function based on the determined rank.

10. The sound spatialization method of claim 6, wherein the determination of the transfer function comprises selecting a variable length sequence of a profile, wherein a length of the variable length sequence depends on the listening level associated with the digital amplifier.

11. The sound spatialization method of claim 6, wherein the determination of the transfer function comprises selecting a profile among a plurality of profiles, wherein each one of the plurality of profiles corresponds to an acquisition of an impulse response in the sound acquisition environment from a different sound acquisition distance.

12. The sound spatialization method of claim 11, further comprising calculating, in real time, a combined profile by combining at least two profiles of the plurality of profiles.

13. Sound spatialization equipment for providing sound spatialization, wherein the sound spatialization equipment comprises a computer configured to execute a process comprising filtering a sound signal with a transfer function, wherein the transfer function is based on an impulse response associated with a sound acquisition environment, and providing, via headphones or loudspeakers, a spatial restitution of sounds based on the filtered sound signal at a listening level associated with a digital amplifier, wherein the computer is further configured to determine the transfer function according to a signal representative of the listening level associated with the digital amplifier.

14. The sound spatialization equipment of claim 13, wherein the transfer function is recorded in a database along with an indicator corresponding to a rank of a sound acquisition distance associated with the transfer function.

15. The sound spatialization equipment of claim 13, wherein the determination of the transfer function comprises selecting the transfer function based on a signal from a man machine interface controlling the digital amplifier.

16. The sound spatialization equipment of claim 13, wherein the determination of the transfer function comprises determining a rank according to the listening level selected on the digital amplifier, and selecting the transfer function based on the determined rank.

17. The sound spatialization equipment of claim 13, wherein the determination of the transfer function comprises selecting a variable length sequence of a profile, wherein a length of the variable length sequence depends on the listening level associated with the digital amplifier.

18. The sound spatialization equipment of claim 6, wherein the determination of the transfer function comprises selecting a profile among a plurality of profiles, wherein each one of the plurality of profiles corresponds to an acquisition of an impulse response in the sound acquisition environment from a different sound acquisition distance.

19. A sound spatialization system, comprising;
a pair of headphones or loudspeakers;
an amplifier;
one or more computing devices configured to:
filter a sound signal with a transfer function, wherein the transfer function is based on an impulse response associated with a sound acquisition environment; and
cause a spatial restitution of sounds to be provided via the pair of headphones or loudspeakers based on the filtered sound signal at a listening level associated with the amplifier,
wherein the transfer function is determined according to a signal representative of the listening level associated with the amplifier.

20. The sound spatialization system of claim 19, further comprising a database of transfer functions, wherein the transfer function is recorded in the database along with an indicator corresponding to a rank of a sound acquisition distance associated with the transfer function.

21. The sound spatialization system of claim 19, wherein the one or more computing devices are further configured to select the transfer function based on a signal from a man machine interface controlling the amplifier.

22. The sound spatialization system of claim 19, wherein the one or more computing devices are further configured to determine a rank according to the listening level selected on the amplifier, and select the transfer function based on the determined rank.

23. The sound spatialization system of claim 19, wherein the one or more computing devices are further configured to select a variable length sequence of a profile, wherein a length of the variable length sequence depends on the listening level associated with the amplifier.

24. The sound spatialization system of claim 19, wherein the one or more computing devices are further configured to select a profile among a plurality of profiles, wherein each one of the plurality of profiles corresponds to an acquisition of an impulse response in the sound acquisition environment from a different sound acquisition distance.

25. The sound spatialization system of claim 24, wherein the one or more computing devices are further configured to calculate, in real time, a combined profile by combining at least two profiles of the plurality of profiles.
